(19) United States
(12) Patent Application Publication
(10) Pub. No.: US 2018/0275961 A1
(43) Pub. Date: Sep. 27, 2018

(54) METHOD AND SYSTEM FOR FAST DATA COMPARISON USING ACCELERATED AND INCREMENTALLY SYNCHRONIZED CYCLIC DATA TRAVERSAL ALGORITHM

(71) Applicant: Cognizant Technology Solutions India Pvt. Ltd., Chennai (IN)

(72) Inventor: Hemant Raskar, Pune (IN)

(21) Appl. No.: 15/681,583

(22) Filed: Aug. 21, 2017

(30) Foreign Application Priority Data
Mar. 23, 2017 (IN) 201741010227

(51) Int. Cl. G06F 7/02; G06F 11/20; G06F 7/06; G06K 9/62; G06F 7/22; G06F 7/38

(52) U.S. Cl. CPC G06F 7/02; G06F 11/2082; G06F 7/06; G06K 9/6201; G06F 19/24; G06F 7/38; G06F 11/2064; G06F 2201/84; G06F 7/22

(57) ABSTRACT

A computer-implemented method and system for providing fast data comparison of large datasets for one or more huge-sized heterogeneous database are disclosed. A source database and a target database are selected from one or more databases. A source dataset and a target dataset are extracted from the selected source database and the target database respectively. Each dataset comprises a plurality of data-strings and each data string is assigned a unique key that facilitates in generating a sequenced-file cache. The data of the cache is read incrementally in order to perform a fast data comparison between the source dataset and the target dataset.

### FIELD OF THE INVENTION

The present invention relates generally to the field of data comparison, and more particularly to fast comparison of databases using cyclic data traversal algorithm.

### BACKGROUND OF THE INVENTION

Software testing is required for an effective performance of a software application or product. Software testing includes data testing and data comparison methods that are generally processed across various enterprises for different types of applications. The most important task in data testing and comparison is to compare large data sets in an optimized manner.

Traditional approaches are known in the art for performing the tasks of optimized data comparisons. One of the approaches includes selecting a source database (srcDB) and a target (tgtDB) database (relational or non-relational) to perform data comparison, based on any business rules and for any context. An intermediate relational database (iDB) is also selected by the users and connection parameters are provided for connecting to the selected intermediate database. A data testing tool is further required that extracts/collects data from the source database using standard SQL queries and then sequentially insert the extracted data into the iDB. The data testing tool then waits for the completion of this process of extraction of data from one database and insertion of the extracted data to another temporary database. The data testing tool then connects to the target database and subsequently extracts data from the target database using standard SQL queries and sequentially inserts the extracted data into the iDB. The data testing tool then again waits for the completion of extraction and insertion job. The data collected in the iDB are sequentially compared by the data testing tool. The results are stored in another temporary database table. In the best case scenario, the data testing tool creates one replica each of source database and target database in the intermediate database. In the worst case scenario, it creates replicas of srcDB and tgtDB, DB for data-difference, and DB for missing data in the iDB. The replicas are later used to create test reports.

The above-discussed approach of data comparison has several limitations such as increase in cost due to the requirement of very high end hardware and the intermediate database to perform comparison of large data-sets. The usage of the intermediate relational database also limits the purpose of comparing the non-relational databases, because even the non-relational data is stored in the relational database format in the iDB. Further, time taken during data comparison is typically very high due to multiple sequential data read-write operations that are repeated on same data-sets. The implementation of intermediate database is also associated with challenges like difficulty in accessing production database servers, inserting data and its replicas on the database instances, data-size limitations, high disk requirements for database instances, reduced performance due to dependency on relational DB instance of intermediate database etcetera.

To address the above-mentioned problems many users opt open source or freeware relational databases as intermediate database (for example: MySql, Oracle Express) which may impose serious challenge of database size and hardware constraints. For example, data comparison of huge databases with large sized data sets including data-table of 4-5 GB and above may be very difficult to execute.

In light of the above, there is a need for a method and a system to provide a faster data comparing and testing technique for huge dataset. Furthermore, there is a need for a method and a system that is independent of databases types including relational and non-relational databases. In addition, there is a need for a system and method to perform fast data testing and comparison without using any intermediate database.

### SUMMARY

A computer-implemented method and a system for providing fast data comparison are provided.

The computer-implemented method comprises the steps of: configuring a computer processor, the computer processor: selecting a source database and a target database from one or more databases; extracting a source dataset and a target dataset respectively from the selected source database and the target database, each dataset comprising a plurality of data-strings; assigning a unique key to each of the plurality of data-strings of each dataset; generating a sequenced-file cache using corresponding unique keys assigned to each of the plurality of data-strings; reading incrementally, the sequenced-file cache, to perform data comparison between the source dataset and the target dataset; reducing incrementally, size of extracted source and target datasets, to perform optimized data-comparison by eliminating any repetition in data-read and data comparison cycles; and storing results of the data comparison process in a data-storage that is accessible to one or more users.

The source datasets and the target datasets are extracted based on extraction configurations provided by a user. The unique key is assigned by using hash algorithm, and acts as a pointer for the selected string that facilitates in fast identification and extraction of data. The one or more databases comprises one or more relational databases and one or more non-relational databases. In various embodiments of the present invention, the one or more databases are local databases, and a network of database servers, and the data comparison between the source dataset and the target dataset is performed using cyclic data traversal algorithm.

Further, the size of extracted source and target datasets is reduced incrementally by marking the data being compared in its corresponding comparison cycle, and subsequently storing the marked data into a plurality of separate datasets including: a separate data-set in the source database; a separate data-set in the target database; one or more data-sets present only in the target database; and one or more matching data-sets from both the source and the target database.

In one embodiment of the present invention, the system for providing fast data comparison comprises: a computer processor, a database module comprising one or more databases, a source database and a target database being selected from the one or more databases; a data extraction and configuration module extracting a source dataset and a target dataset respectively from the selected source database and the target database, each dataset comprising a plurality of data-strings and a unique key is assigned to each of the plurality of data-strings of each dataset; a data storage and management module generating a sequenced-file cache using corresponding unique keys assigned to each of the plurality of data-strings identifiers; and a fast data comparison module incrementally reading the sequenced-file cache to perform data comparison between the source dataset and the target dataset, and incrementally reducing size of extracted source and target datasets, to perform optimized data-comparison by eliminating any repetition in data-read and data comparison cycles.

In one embodiment of the present invention, a computer program product is provided. The computer program product comprises a non-transitory computer readable medium having computer readable program code stored thereon, the computer readable program code comprising instructions that, when executed by at least one computer processor, cause the at least one computer processor to: select a source database and a target database from one or more databases; extract a source dataset and a target dataset respectively from the selected source database and the target database, each dataset comprising a plurality of data-strings; assign a unique key to each of the plurality of data-strings of each dataset; generate a sequenced-file cache using corresponding unique keys assigned to each of the plurality of data-strings identifiers; and read incrementally, the sequenced-file cache, to perform data comparison between the source dataset and the target dataset; and reduce incrementally, size of the extracted source and target datasets, to perform optimized data-comparison by eliminating any repetition in data-read and data comparison cycles.

### BRIEF DESCRIPTION OF THE ACCOMPANYING DRAWINGS

The present invention is described by way of embodiments illustrated in the accompanying drawings wherein:

FIG. 1 is a block diagram illustrating a system for providing fast data comparison, in accordance with an embodiment of the present invention;

FIG. 2 is a block diagram of the fast data comparison module, in accordance with an embodiment of the present invention;

FIG. 3 is a flowchart illustrating a method for providing fast data comparison, in accordance with an embodiment of the present invention;

FIGS. 3a to 3e is a detailed flowchart illustrating the execution steps of the fast data comparison method according to the embodiments of the present invention; and

FIG. 4 illustrates an exemplary computer system in which various embodiments of the present invention can be implemented.

### DETAILED DESCRIPTION OF THE INVENTION

A method and a system for providing fast data comparison of large datasets for one or more huge-sized heterogeneous database are disclosed. The invention provides for a method and system that facilitate the users to extract data from various types of databases using single read operation and to perform fast comparisons of the extracted data. Further, the invention provides for a method and system for implementing cyclic data traversal algorithm and hash management for providing fast data comparison of data residing in one or more databases. In addition, the invention provides for a method and system for implementing memory management techniques to facilitate a user to optimally use the available memory and other hardware for the fast data comparison.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

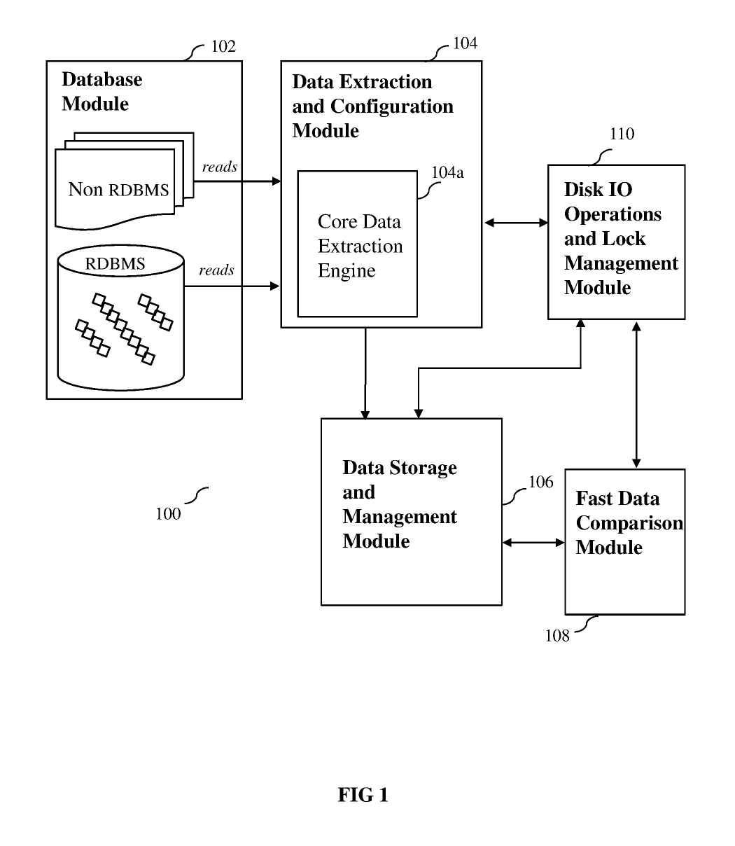

FIG. 1 is a block diagram illustrating a system 100 for providing fast data comparison, in accordance with an embodiment of the present invention. The system 100 comprises a database module 102, a data extraction and configuration module 104, a data storage and management module 106, a fast data comparison module 108, and a disk I/O (Input/Output) operations and management module 108.

The database module 102 comprises one or more relational databases (RDBMS) and one or more non-relational databases (non-RDBMS). In one embodiment of the present invention, the database module is a network of database servers that is accessible from various locations. Network locations may be provided by the users to connect to the required database for access. In various embodiments of the present invention, the database module may be accessed by the users across the network via one or more communication mediums. The one or more RDBMSs and non-RDBMS s may be used as either source or target database according to the requirement of the users for the data comparison process. For example, a relational database may be used as either a source database or target database for extracting the data for comparison. In a similar way, a non-relational database may be used as either a source database or target database for extracting the data for comparison. Each database, RDBMS or non-RDBMS, is read by the data extraction and configuration module 104 for data extraction. The database module 102 further comprises a dynamic data reader that reads specific data from the relational databases or the non-RDBMS database. The dynamic data reader, based on extraction configurations, is used for RDBMS-specific data extraction according to the user preferences and requirements. This facilitates dynamic data selection and dynamic data aggregation. For example data pertaining to aggregation rules, data-transformation, and various data-types etcetera are selected and aggregated. Further, the extracted data is stored in file system facilitating easy and fast access for further processing

The data extraction and configuration module 104 extracts specific data from the database module 102 by reading the data stored in the specific database, i.e. non-RDBMS and RDBMS. The data is extracted by reading one or more data sets of different sizes and the extracted data is stored and organized in sequence of a plurality of files in a file system or a cache. Also, the data is extracted from the databases to a given file without using standard SQL (Structured Query Language) queries. Thus, the data is extracted directly into the file system of any available file location of network/local server without requiring any intermediate database. The data extraction and configuration module 104 is a user defined module that facilitates one or more users to store and fetch user-defined requirements and preferences for data comparison and testing. In one embodiment of the present invention, the data extraction and configuration module 104 receives and stores user inputs in specific configuration data formats) The data extraction and configuration module 104 comprises a core data extraction engine 104a that implements hash algorithm to facilitate a faster extraction of data. The core data extraction engine 104a is a computer processor that receives user defined configurations via the data extraction and configuration 104 and also reads the data stored in the RDBMS. The core data extraction engine 104a then performs sequential traversal of the data and also performs mapping of data-sets using hashed-string-identifiers to data. Originally extracted data-set strings from source and target database are used to generate short hashed-string-identifiers, and each of the original data-set strings are mapped with unique key. The assigned unique key of the given data-set strings acts as a pointer for the selected string that facilitates in fast identification and extraction of data from the extracted data-sets. In one embodiment of the present invention, this key-value mapping for extracted source and target data-sets is further used to create persistent sequenced-file-cache or caskets.

The data storage and management module 106 creates the file system or the file cache to store the data extracted from the database module 102. The extracted data is exported to the cache in various forms of small, medium and large files based on the available system memory. Based on the available memory-size, the size of the files in cache is decided, the data is mapped, and the files are sequenced within the cache. In various embodiments of the present invention, segmentation of data is carried out during the process of mapping and sequencing. The simultaneous operations of mapping, sequencing, and segmenting the data, save the processor's execution time. This also allows minimum server execution-occupancy by the processor, as the file cache itself becomes an organized file sequence of the extracted data that facilitates a user to obtain optimized output in lesser time as compared to the conventional methods of data-extraction, transformation, data mapping and comparison. This method of storing data in sequenced-file cache also ensures that no duplicate records are present in source or target file cache without need to explicitly perform process to remove-duplicate data-sets. In one embodiment of the present invention, the file-cache is a distributed cache for providing a quicker and faster data-access to the users.

The data storage and management module 106 comprises a data reader that reads the extracted data from the data extraction module 104. The data storage and management module 106 further comprises a data writer that writes the data into the file cache. Thus the data is extracted directly into the file system of the server where this solution is being deployed without requiring any external software and hardware support such as an intermediate database or additional hardware computing resources respectively.

The fast data comparison module 108 is the core engine of the system 100. The fast data comparison module 108 analyses the extracted data received from the data extraction and configuration module 104 and executes accelerated and incrementally synchronized cyclic data traversal algorithm for obtaining fast data comparison. In various embodiments of the present invention, the fast data comparison module 108 performs the fast data comparison of required datasets irrespective of their data-size and irrespective of free RAM (Random Access Memory) available to the user for testing. Also, the comparison of data can be performed dynamically for any data-types i.e. relational or non-relational, data size, and data structure e.g. same or different data-sets.

In one embodiment of the present invention, the fast data comparison module 108 facilitates the users to view, sort, and filter the data-objects obtained in the output or comparison results. The users may view one or more data differences for each pair of data-sets under test, and can quickly navigate through data differences via the external user interface. The fast data comparison module 108 also provides different data-sets in raw format for future use and applications, as required by the users. The fast data comparison module 108 is also capable of providing data-comparison in absence of primary keys or indices in case of relational databases.

The disk I/O operations and lock management module 110 performs the read-write operation or the I/O (input/output) operations. The data from various modules of the system is read and the output is written at various specific locations of one or more storage devices such as hard disks of the server. The disk read-write operations are fast operations as compared to the conventional RDBMS read-writes using SQL queries, since only single read is performed for storing the complete file system into the hard disks at a local server, or hard disks of remote servers at various network locations. Also, the stored file system is available to the users for access.

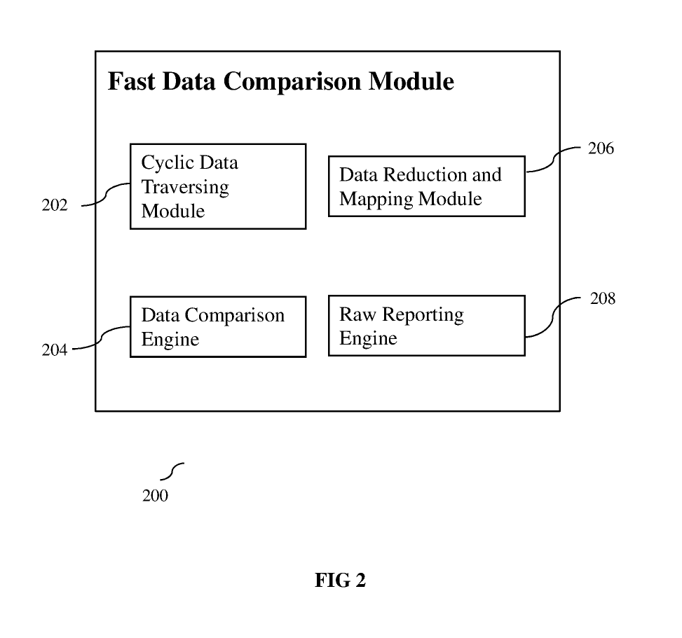

FIG. 2 is a block diagram of the fast data comparison module, in accordance with an embodiment of the present invention. The fast data comparison module 200 comprises a cyclic data traversing module 202, a data comparison engine 204, a data reduction and mapping module 206, and a raw reporting engine 208.

The cyclic data traversing module 202 executes the accelerated and incrementally synchronized cyclic data traversing algorithm for providing fast data comparison. The cyclic data traversing module 202 uses system-created and sequenced file cache in order to randomly read the data to overcome the problems associated with sequential read-write operations. This process is simultaneously synchronously executed for source file-cache and target file-cache and data is incrementally provided to the data comparison engine 204 at the same time. The cyclic data traversing module is constantly monitored for memory to optimally use system hardware resources using functionality or a module. In one embodiment of the present invention, the cyclic data traversing module 202 incrementally and exponentially increases the performance of data-comparison tasks based on disk space and computing power of the processor and due to data reduction mechanism of the algorithm. The cyclic data traversing module 202 works in conjunction with the data comparison engine 204 so as to concurrently perform data-traversing and data-comparison operation in order to reduce execution time.

The data comparison engine 204 is configured to compare data from a source database with data from a target database by using the mapping algorithm. A set of rules pertaining to comparing and mapping process may be predefined by the data comparison engine 204 to execute the comparison process. The set of rules defines the conditions required for the comparison and mapping. In one embodiment of the present invention, the mapping is performed based on the predefined hashing-rules comprising defining one or more key values that can be uniquely assigned to the data being compared. Each set of data of the file sequence is assigned a unique key value so that accurate data can be randomly pulled out for data comparison and testing. The comparison of data is performed in the original form of the data as stored in the source and the target databases using this unique key and not actual data. Unique key being actually generated and inherited from original data giving complete snapshot of actual data, comparison is way faster and accurate without any transformation needed. The form of the data is not changed or transformed into a different form prior to the comparison and testing. For example, data stored in relational database may have a different form as compared to the form of data residing in the relational or non-relational database. The different forms of data in different databases do not affect the process of data comparison by the data comparison engine 204. This mechanism saves tremendous amount of time-overheads associated with data-transformation of data originating from heterogeneous data-sources. The data comparison engine 204 evaluates and compares the data-sets, passing comparison-result to the data reduction and mapping module 206.

The data reduction and mapping module 206 is configured to incrementally reduce data-read-cycles as execution progresses. It provides a common algorithm for all types of data to be compared and for any type of data sources. The total number of data cycles required for the complete process of data comparison is reduced by ensuring that a set of data is not read and compared again with the previously read and compared data set. Based on the result of comparison of After each cycle of execution of comparison of a data-set, a flag is marked to indicate that the data set has been already compared and need not be read by the processor for further comparison and that no redundant comparison is executed. Based on the comparison result, the data reduction and mapping module 206 performs create/write, delete and update operations on source and target file-cache. This is based on four major comparison result status including same data-set present in source and target, source data-set not present in target, source data-set being different than corresponding target data-set, and target data-set not present in source. This finally results in having four different file-cache systems representing. Data-set pointers for different data-set in source database b. Data-sets present only in target database c. Matching Data-sets from source and target database d. Different Data-sets when source compared with target. This optimization performed in each cycle incrementally reduces size of source and target file-cache decreasing read-write time for each of the next cycle. This reduces the overall execution time of the processor, resulting in a faster data traversal and comparison process. Thus the reduction of data cycle is incrementally achieved as the execution of the data comparison of the entire dataset progresses. The execution is therefore accelerated in the later cycles of execution of the comparison process.

The raw reporting engine 208 is configured to provide different data-sets in raw format for future use and applications, as required by the users.

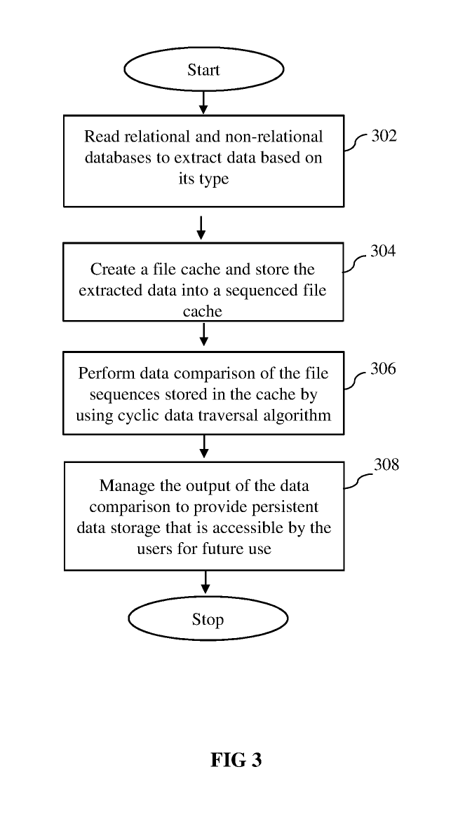

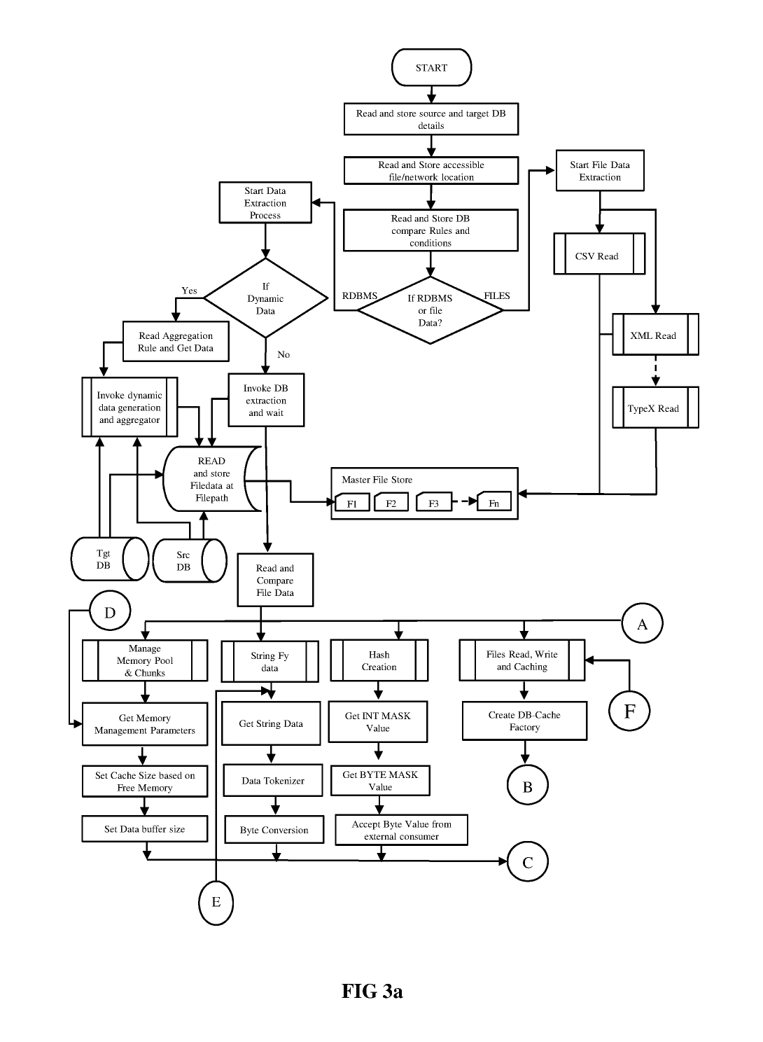

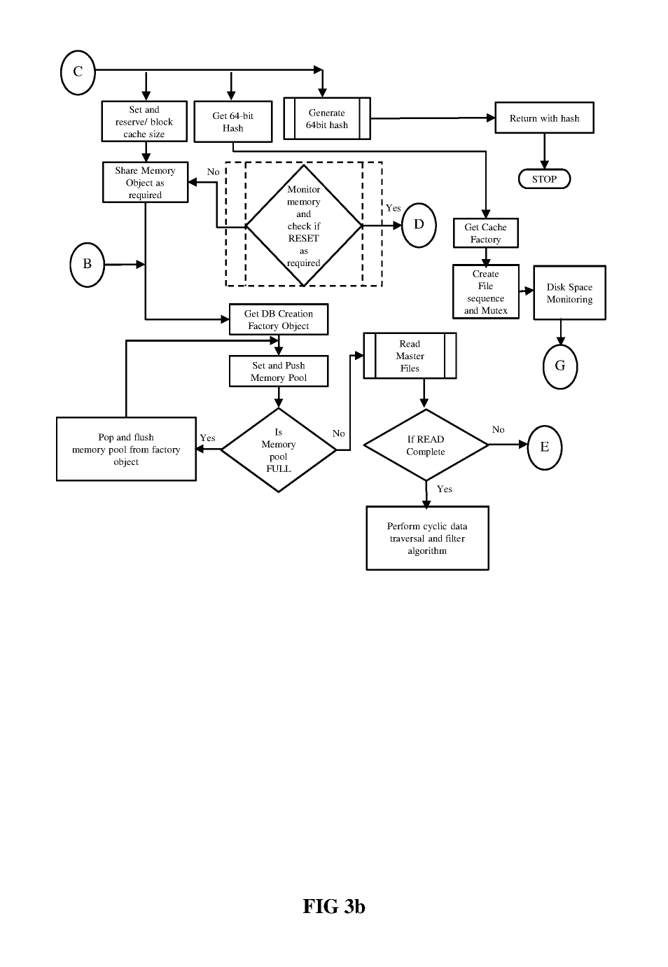

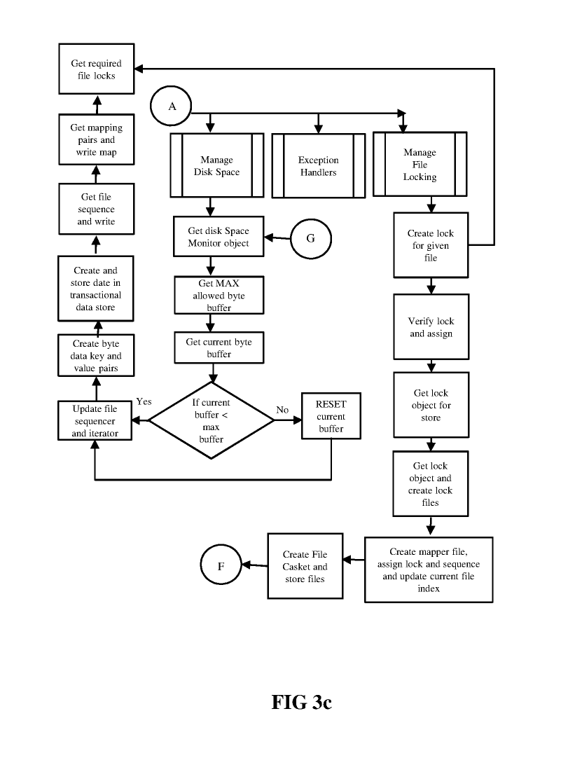

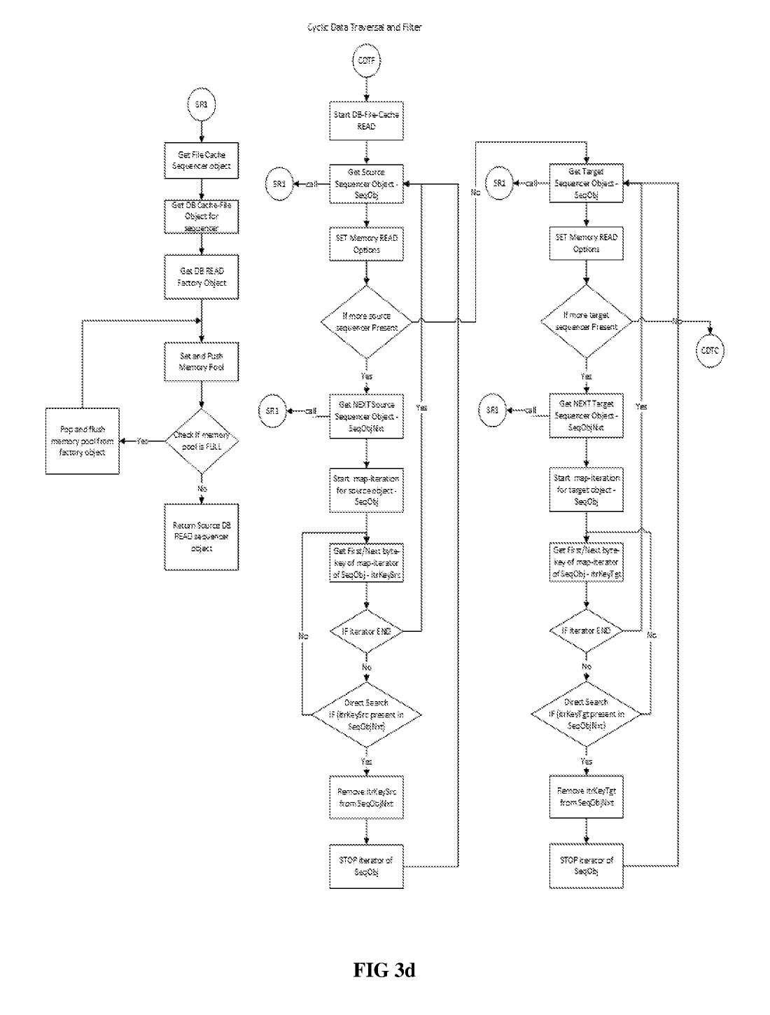

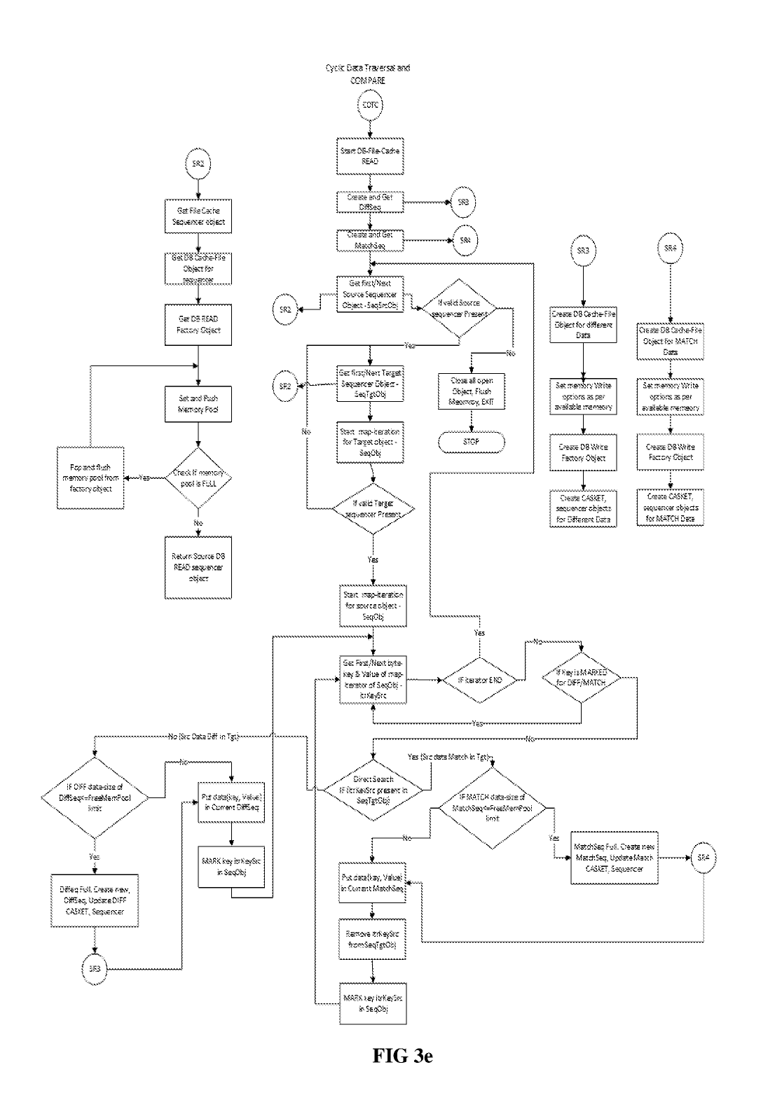

FIG. 3 is a flowchart illustrating a method for providing fast data comparison, in accordance with an embodiment of the present invention. FIGS. 3a to 3e show detailed flowcharts illustrating the execution steps of the fast data comparison method according to the embodiments of the present invention. Referring now to FIG. 3, at step 302, one or more databases are read to extract data for comparison. The one or more databases include one or more relational (RDBMS) and one or more non-relational (non-RDBMS) databases that store various data in different formats. A source dataset and a target dataset are selected from the one or more databases. The one or more RDBMSs and non-RDBMSs may be used as either source or target database according to the requirement of the users for the process of data comparison. Data from one or more source and target databases are read and stored. Various network locations and local files of different sizes and types are also accessed to read and store the data for comparison. One or more set of rules pertaining to comparison process for the various databases are read and stored. Thereafter, relational and non-relational data are extracted and the extracted data is stored in file sequences. Thus, a master file store is created that is an organized file system or file cache.

At step 304, a file cache is created and the extracted data is stored in the sequenced-file cache. The data is extracted by reading one or more data sets of different sizes and the extracted data are stored and organized in sequence of a plurality of files in the file system or the cache. Also, the data is extracted from the databases to a given file without using standard SQL queries and without using any intermediate database and sequenced-file cache are generated using unique data-strings identifiers out of the extracted data and hash creation. Data for comparison is read from the cache.

At step 306, data comparison of the file sequences stored in the cache is performed. The data comparison is performed by using accelerated and incrementally synchronized cyclic data traversal algorithm wherein data reduction and mapping is performed to incrementally reduce data-read-cycles as execution progresses. The total number of data cycles required for the complete process of data comparison is reduced by ensuring that a set of data is not compared with the previously compared data set. The incrementally synchronized cyclic data traversal algorithm comprises the steps of file read write and caching, updating file-cache, managing disk space and managing file locking.

At step 308, the output or result of the data comparison process is managed to provide a persistent data storage that is accessible to the users for future use, such as reporting, auditing etcetera. Memory management parameters are predefined and a set of memory management parameters is fetched to set the cache size based on the free memory available to the user. Once the cache size is set, it is reserved or blocked for the use of data comparison process. The cache is also continuously monitored to check if memory or the cache is full or if it has been RESET. Accordingly, a new set of memory management parameters is fetched from the predefined parameters to set and block the cache size for a new set of data.

FIGS. 3a to 3e show detailed flowcharts illustrating the execution steps of the fast data comparison method according to the embodiments of the present invention. The figures illustrate the step of generating a unique key for representing a given data-string. The figures also illustrate several intermediate steps involved in the process of unique key generation. The intermediate steps include the steps of data tokenization, byte conversion, hash key generation involving the functions of get-INT-MASK and get-BYTE-MASK. The above-mentioned intermediate steps are executed by one or more modules to process single data-string from originally extracted data-files from source and target databases.

Data Tokenization: While reading individual data-strings from the huge extracted data-file from original database, it is required to efficiently process and fetch the data. Data tokenizer is a multithreaded module designed to perform the task of data tokenization by reading data in a streaming way, cleansing the data for user-inserted data-characters and submitting the individual data-string sets towards the byte conversion module or function in a piped fashion in order to perform read and write operations separately.

Byte Conversion: In order to completely represent the given data-string set, it is required to optimize the memory footprints of data-string-identifiers. Being the most preliminary, machine-level data-types, these cleansed data-string sets are converted to byte format and then submitted for hash-key generation.

Hash key generation: Hash key is generated to represent the whole data-string-set of unaligned-variable-length array of bytes by converting it into human-readable unique identifier which is used for mapping the given data-string set in sequenced-file cache. Also, in order to support high-performance during the process, these identifiers can have either 32-bit or 64-bit values. INT_MASK and BYTE_MASK are ‘long’ values (typically set to 0x00000000ffffffffL, and 0x00000000000000ffL respectively) and are being used for bitwise operations, particularly in bit-field for setting multiple bits in a byte with either an ‘ON’ or an ‘OFF’. This helps in clearing string-buffers by greatly reducing its size and restricting the size of hash table to powers of two sizes.

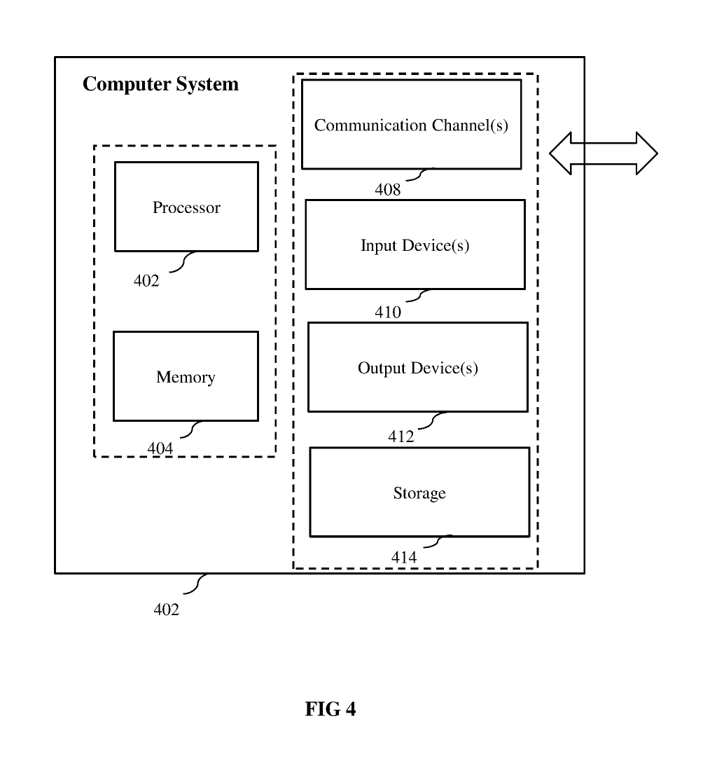

FIG. 4 illustrates an exemplary computer system in which various embodiments of the present invention may be implemented. The computer system 402 comprises a processor 404 and a memory 406. The processor 404 executes program instructions and may be a real processor and/or a virtual processor. The computer system 402 is not intended to suggest any limitation as to scope of use or functionality of described embodiments. For example, the computer system 402 may include, but is not limited to, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components including one or more communication channels 408, one or more input devices 410, one or more output devices 412, and storage 414. An interconnection mechanism (not shown) such as a bus and other network components, interconnects the components of the computer system 402. In various embodiments of the present invention, operating system software provides an operating environment for various processes being executed in the computer system 402, and manages different functionalities of the components of the computer system 402.

The communication channel(s) 408 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 410 may include, but not limited to, a keyboard, mouse, a voice input device, a scanning device, or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but is not limited to, magnetic disks, magnetic tapes, CD-ROMs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but is not limited to optical or analogue communications channel(s) 408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A computer implemented method for providing fast data comparison, the computer implemented method comprising the steps of:
configuring a computer processor, the computer processor:
selecting a source database and a target database from one or more databases;
extracting a source dataset and a target dataset respectively from the selected source database and the target database, each dataset comprising a plurality of data-strings;
assigning a unique key to each of the plurality of data-strings of each dataset;
generating a sequenced-file cache using corresponding unique keys assigned to each of the plurality of data-strings;
reading incrementally, the sequenced-file cache, to perform data comparison between the source dataset and the target dataset; and
reducing incrementally, size of extracted source and target datasets, to perform optimized data-comparison by eliminating any repetition in data-read and data comparison cycles.

2. The method as claimed in claim 1, further comprising the step of storing results of the data comparison process in a data-storage that is accessible to one or more users.

3. The method as claimed in claim 1, wherein the source datasets and the target datasets are extracted based on extraction configurations provided by a user.

4. The method as claimed in claim 1, wherein the unique key is assigned by using hash algorithm.

5. The method as claimed in claim 1, wherein the unique key acts as a pointer for the selected string that facilitates in fast identification and extraction of data.

6. The method as claimed in claim 1, wherein the one or more databases comprises one or more relational databases and one or more non-relational databases.

7. The method as claimed in claim 1, wherein the one or more databases are local databases, and a network of database servers.

8. The method as claimed in claim 1, wherein the data comparison between the source dataset and the target dataset is performed using cyclic data traversal algorithm.

9. The method as claimed in claim 1, wherein the size of extracted source and target datasets is reduced incrementally by marking the data being compared in its corresponding comparison cycle, and subsequently storing the marked data into a plurality of separate datasets including:
a. a separate data-set in the source database;
b. a separate data-set in the target database;
c. one or more data-sets present only in the target database; and
d. one or more matching data-sets from both the source and the target database.

10. A system for providing fast data comparison, the system comprising:
a computer processor configuring:
a database module comprising one or more databases, a source database and a target database being selected from the one or more databases;
a data extraction and configuration module extracting a source dataset and a target dataset respectively from the selected source database and the target database, each dataset comprising a plurality of data-strings and a unique key is assigned to each of the plurality of data-strings of each dataset;
a data storage and management module generating a sequenced-file cache using corresponding unique keys assigned to each of the plurality of data-strings identifiers; and
a fast data comparison module incrementally reading the sequenced-file cache to perform data comparison between the source dataset and the target dataset, and incrementally reducing size of extracted source and target datasets, to perform optimized data-comparison by eliminating any repetition in data-read and data comparison cycles.

11. The system as claimed in claim 10, wherein the data storage and management module stores results of the data comparison process and is accessible to one or more users.

12. The system as claimed in claim 10, wherein the source datasets and the target datasets are extracted based on extraction configurations provided by a user.

13. The system as claimed in claim 10, wherein the unique key is assigned by using hash algorithm.

14. The system as claimed in claim 10, wherein the unique key acts as a pointer for the selected string that facilitates in fast identification and extraction of data.

15. The system as claimed in claim 10, wherein the one or more databases comprises one or more relational databases and one or more non-relational databases.

16. The system as claimed in claim 10, wherein the one or more databases are local databases, and a network of database servers.

17. The system as claimed in claim 10, wherein the data comparison between the source dataset and the target dataset is performed using cyclic data traversal algorithm.

18. The system as claimed in claim 10, wherein the size of extracted source and target datasets is reduced incrementally by marking the data being compared in its corresponding comparison cycle, and subsequently storing the marked data into a plurality of separate datasets including:
a separate data-set in the source database;
a separate data-set in the target database;
one or more data-sets present only in the target database; and
one or more matching data-sets from both the source and the target database.

19. A computer program product comprising:
a non-transitory computer readable medium having computer readable program code stored thereon, the computer readable program code comprising instructions that, when executed by at least one computer processor, cause the at least one computer processor to:
select a source database and a target database from one or more databases;
extract a source dataset and a target dataset respectively from the selected source database and the target database, each dataset comprising a plurality of data-strings;
assign a unique key to each of the plurality of data-strings of each dataset;
generate a sequenced-file cache using corresponding unique keys assigned to each of the plurality of data-strings identifiers; and
read incrementally, the sequenced-file cache, to perform data comparison between the source dataset and the target dataset; and
reduce incrementally, size of the extracted source and target datasets, to perform optimized data-comparison by eliminating any repetition in data-read and data comparison cycles.
